(19) United States
(12) Patent Application Publication
(10) Pub. No.: US 2011/0142543 A1
(43) Pub. Date: Jun. 16, 2011

(54) Method of Using Sacrificial Pipe String

(75) Inventor: Jimmy E. Griffin, Houston, TX (US)

(73) Assignee: Subsea 7 Limited, Westhill Aderdeenshire (GB)

(21) Appl. No.: 12/715,841

(22) Filed: Mar. 2, 2010

Related U.S. Application Data
(60) Provisional application No. 61/286,167, filed on Dec. 14, 2009.

(51) Int. Cl. F16L 1/12

(52) U.S. Cl. 405/173

(57) ABSTRACT

The present disclosure is directed to a method and system of laying pipe using a sacrificial pipe string to extend the length of an A&R winch wire. In one aspect, present disclosure is directed to a method of positioning a flowpipe on a sea floor from a vessel. The method includes lowering a first end of a flowpipe from the vessel. Additionally, the method includes connecting a pipeline end termination to a second end of the flowpipe. Also, the method includes connecting a first end of a sacrificial pipe to the pipeline end termination. In addition, the method includes connecting a winch wire to a second end of the sacrificial pipe. Furthermore, the method includes lowering the sacrificial pipe with the winch wire so that the pipeline end termination rests on the sea floor. Additionally, the method includes disconnecting the sacrificial pipe from the pipeline end termination.

### RELATED APPLICATION

This application claims the benefit of priority of U.S. Provisional Application No. 61/286,167 Filed Dec. 14, 2009 entitled “Method of Using Sacrificial Pipe String,” the disclosure of which is incorporated herein by reference in its entirety.

### FIELD OF THE INVENTION

This application relates to a method of laying pipe in a deep drilling field.

### BACKGROUND

It is well known to lay pipe on a sea floor for conveying oil, gas, and the like between two sites, such as a production well and adjacent production platform. Typically, a pipelaying vessel is used to discharge the pipe from a pipe storage drum on the vessel down into the sea while the vessel advances on the sea surface. Typical pipe frequently adopts the shape of a catenary between the pipelaying vessel and the sea floor. The pipe may be a flexible pipe or, alternatively, it may be a rigid (metal-walled) pipe, which requires to be passed through a straightener on the vessel after it has been drawn off the pipe storage drum. This removes the plastic deformation that it may have undergone when it was initially wound onto the drum.

During pipelaying operations, it is necessary to complete the laying of each pipe length by lowering onto the sea floor the surface end (i.e. the second end) of the pipe that is being laid. To lay the pipe, an abandonment and recovery (A&R) winch has conventionally been used. The winch line, which may take the form of wire, cable, or synthetic rope, is attached to an end portion of the pipe and the winch is operated to lower and lift the pipe, as required.

However, in some circumstances, such as when laying pipe in a very deep field, the winch line on the A&R winch may be too short to reach the sea floor. Regulations prohibit splicing the winch line to make it longer, and because the winch lines are expensive, it may be cost prohibitive to outfit each vessel with an extra long winch line that might be seldom used. In addition, because the winch lines have such large diameters to provide sufficient strength, they require large storage drums. Since space on a vessel can be limited, storage space for larger drums also may be limited.

The subject matter of the present disclosure overcomes one or more of the shortcomings of the prior art.

### SUMMARY

The present disclosure is directed to a method and system of laying pipe using a sacrificial pipe string to extend the length of an A&R winch wire. In one aspect, present disclosure is directed to a method of positioning a flowpipe on a sea floor from a vessel. The method includes lowering a first end of a flowpipe from the vessel. Additionally, the method includes connecting a pipeline end termination to a second end of the flowpipe. Also, the method includes connecting a first end of a sacrificial pipe to the pipeline end termination. In addition, the method includes connecting a winch wire to a second end of the sacrificial pipe. Furthermore, the method includes lowering the sacrificial pipe with the winch wire so that the pipeline end termination rests on the sea floor. Additionally, the method includes disconnecting the sacrificial pipe from the pipeline end termination.

In another aspect, the present disclosure is directed to a method of positioning a flowpipe on a sea floor from a floating vessel. The method includes determining that a depth to the sea floor is inaccessible via a winch wire. Also, the method includes lowering a first end of a flowpipe from the vessel. Additionally, the method includes connecting a pipeline end termination to a second end of the flowpipe. Furthermore, the method includes connecting a first end of a sacrificial pipe to the pipeline end termination. In addition, the method includes connecting a winch wire to a second end of the sacrificial pipe. Additionally, the method includes lowering the sacrificial pipe with the winch wire until the pipeline end termination rests on the sea floor. Also, the method includes disconnecting the sacrificial pipe from the pipeline end termination.

A further method for positioning a flowpipe on a sea floor from a floating vessel is disclosed. The method includes determining that the sea floor is inaccessible via a winch wire. Additionally, the method includes creating a perceived length of the winch wire different than the actual length so that the sea floor is accessible via the perceived length of the winch wire. The creating the perceived length of the winch wire includes connecting a sacrificial pipe to the winch wire, so that the perceived length of the winch wire is increased by the sacrificial pipe's length. Also, the method includes positioning the flowpipe on the sea floor at the depth using the perceived length of the winch wire.

A system for laying flowpipe on a sea floor from a floating vessel is disclosed. The system includes a sea-going vessel comprising a winch. The winch having a winch wire having a winch wire length. The winch wire length being less than a distance from the sea-going vessel to the sea floor. Also, the system includes a flowpipe segment disposed on the sea floor. Additionally, the system includes a PLET disposed at an end of the flowpipe at a depth greater than the winch wire length. Furthermore, the system includes a sacrificial pipe having a pipe length. The sacrificial pipe being connected to and disposed between the PLET and the winch wire. The winch wire and the sacrificial pipe lengths together exceeding the distance from the vessel to the sea floor.

### BRIEF DESCRIPTION OF THE DRAWINGS

Aspects of the present disclosure are best understood from the following detailed description when read with the accompanying figures.

FIG. 1 shows an exemplary system for laying pipe on a sea floor.

FIG. 2 is a flow chart detailing a method using the exemplary system of FIG. 1 for laying pipe on a sea floor.

FIG. 3 is an illustration of a vessel lay system for use on a vessel with a sacrificial pipe, a PLET, and a flowpipe from the exemplary system of FIG. 1.

FIG. 4 is an illustration of the sacrificial pipe, PLET, and flowpipe being fed off the vessel from the exemplary system of FIG. 1.

FIG. 5 is an illustration of the sacrificial pipe connected between a winch wire and the PLET from the exemplary system of FIG. 1.

FIG. 6 is an illustration of the PLET and a section of the sacrificial pipe showing an interface used as a disconnection point between the PLET and the sacrificial pipe from the exemplary system of FIG. 1.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

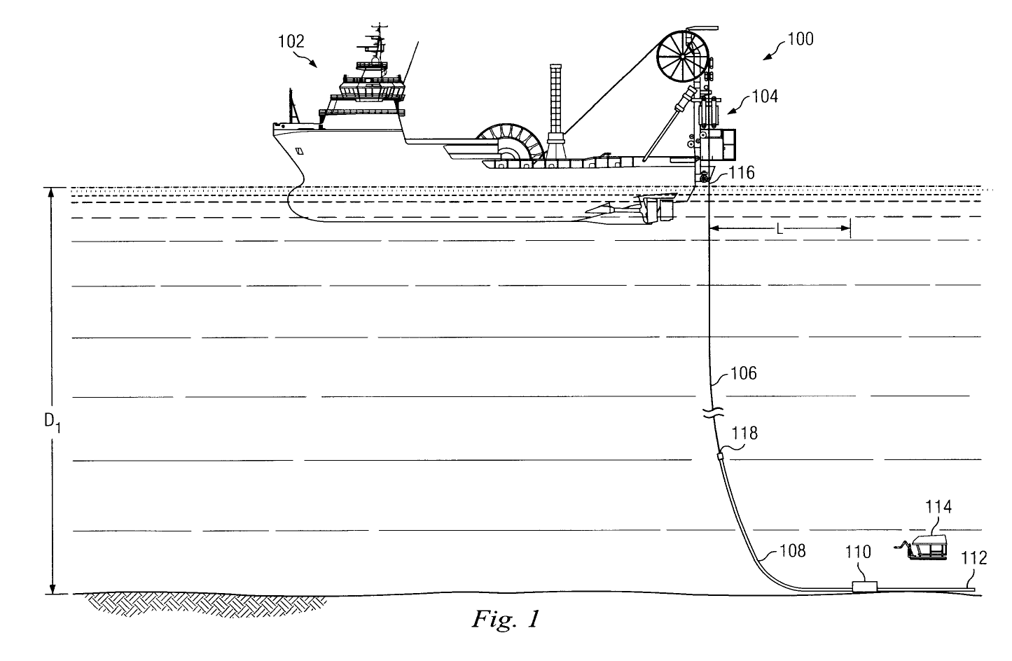

FIG. 1 shows an exemplary system 100 for laying pipe on a sea floor. In the example shown, system 100 includes a vessel 102, a lay system 104, an abandonment and recovery (A&R) winch wire 106, a sacrificial pipe 108, a pipeline end termination 110 (PLET), a flowpipe 112, and a remote operated vehicle (ROV) 114. As will be described in greater detail below, the system 100 and the accompanying method described herein enable pipelayers to lay a flowpipe along a sea floor at depths that exceed the length of an abandonment and recovery (A&R) winch wire.

In addition, system 100 and the accompanying method described herein may be useful when the straight line length of the wire exceeds the sea depth, but other factors such as the cantenary shape of the A&R winch wire 106 and/or the layback distance of vessel 102 relative to the PLET 110 affect the wire's ability to reach the sea floor. Therefore, any discussion herein of the length of A&R winch wire 106 not being long enough to reach the sea floor and/or the length of A&R winch wire 106 being shorter than the depth to the sea floor are meant to include circumstances when the A&R winch wire 106 does not reach the sea floor due to factors such as the cantenary shaper of A&R winch wire 106, layback distance of vessel 102, and/or other similar factors.

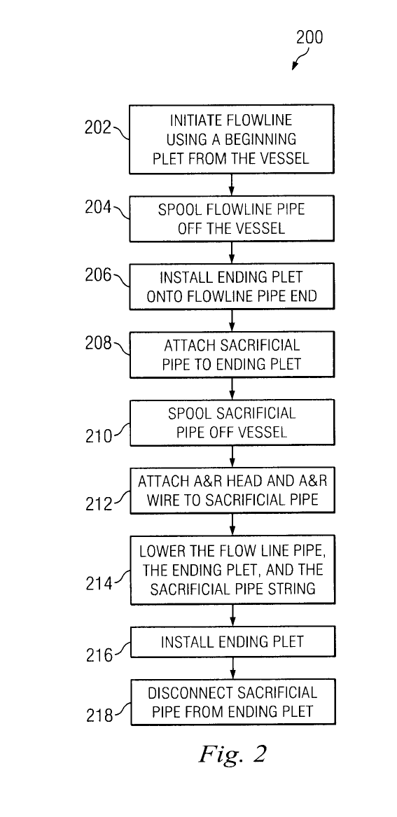

FIG. 2 illustrates an exemplary method 200 using system 100 for extending the perceived length of the A&R winch wire 106 using sacrificial pipe 108. As used herein, the term “perceived length” of the A&R winch wire 106 corresponds to the actual length of the A&R winch wire 106 combined with the actual length of sacrificial pipe 108 used to reach the sea floor. Also, as used herein, sacrificial pipe is the length of pipe used only to increase the perceived length of the winch wire, and is not used for transportation of obtained oil, gas, or the like. The method may be particularly advantageous when a pipelayer determines that the sea floor is in water deeper than the actual length of the A&R winch wire 106. In other words, the method's advantages arise when the sea floor is inaccessible via the A&R winch wire 106.

As shown in FIG. 1, A&R winch wire 106 has a length extending from a proximal end 116 to a distal end 118 of A&R winch wire 106. For purposes of this explanation, the winch wire 106 is shorter than the depth D₁ of the water. The distance between the water depth D₁ and the length of the A&R winch wire 106, taking into account any catenary shape of sacrificial pipe 108 and/or A&R winch wire 106 between the vessel 102 and the sea floor may be used to determine the length of sacrificial pipe 108 necessary to lengthen the perceived length of A&R winch wire 106. As discussed above, the perceived length of A&R winch wire 106 corresponds to the actual length of the A&R winch wire 106 combined with the actual length of sacrificial pipe 108 used to reach the sea floor. Therefore, combining the sacrificial pipe 108 with the A&R winch 106 alters the perceived length of A&R winch wire 106 so that the system 100 can lay flowpipe 112 along the sea floor at depth D₁, where the depth D₁ exceeds the actual length of A&R winch wire 106.

Referencing FIG. 2, method 200 begins at a step 202 by initiating discharge of the flowpipe 112 in a conventional manner using PLET 110 from vessel 102. In one example, vessel 102, is a Seven Oceans vessel provided by Subsea 7. The flowpipe 112 may be a flexible pipe or, alternatively, it may be a rigid (metal-walled) pipe or other type of conventional pipe. In one example, flowpipe 112 is a rigid pipe such as a straight carbon steel pipe. In other examples, flowpipe 112 is a flexible pipe composed of intermeshing materials that enable flexibility. It should be noted that the various types of flowpipes and/or sacrificial pipes described herein are for exemplary purposes only and are not to be construed as limiting the present disclosure to a specific type of flowpipe and/or sacrificial pipe.

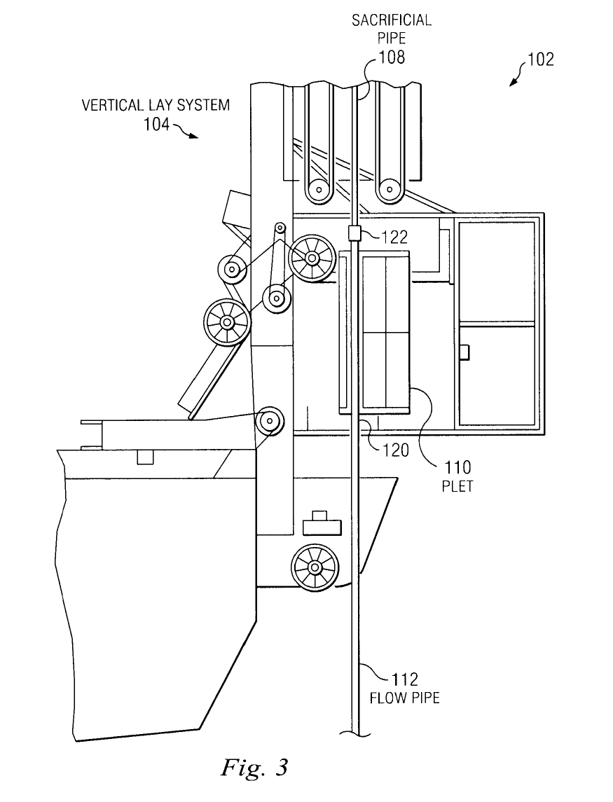

At a step 204, flowpipe 112 that is rolled on the vessel's main reel is spooled off the vessel 102. At a step 206, once the complete flowpipe 112 has been spooled off the reel, the pipe is cut and PLET 110 is installed on the end of flowpipe 112. This may be accomplished by welding the PLET 110 to the flowpipe 112 while the PLET 110 is in the workstation of a lay system, such as lay system 104 on the vessel 102. At a step 208, instead of attaching the A&R winch line 106 to the PLET yoke, sacrificial pipe 108 is attached the PLET yoke. This step is described in greater detail with reference to FIG. 3.

FIG. 3 shows vessel 102 with lay system 104 disposed thereon. For example, lay system 104 can be a vertical lay system, a reel lay system, or any other type of lay system. Here, the lay system 104 is feeding out flowpipe 112 off the vessel 102. Attached to a distal end 120 of the flowpipe 112 and still in the lay system 104, rests the PLET 110. At a proximal end 122 of the yoke of the PLET, the sacrificial pipe 108 has been secured to support the PLET 110. In some instances, the sacrificial pipe 108 is the same dimension as the flowpipe 112, and in some cases, may be identical in structure to the flowpipe 112. For example, in some cases, the sacrificial pipe 108 may be from the same roll or spool as the flowpipe 112.

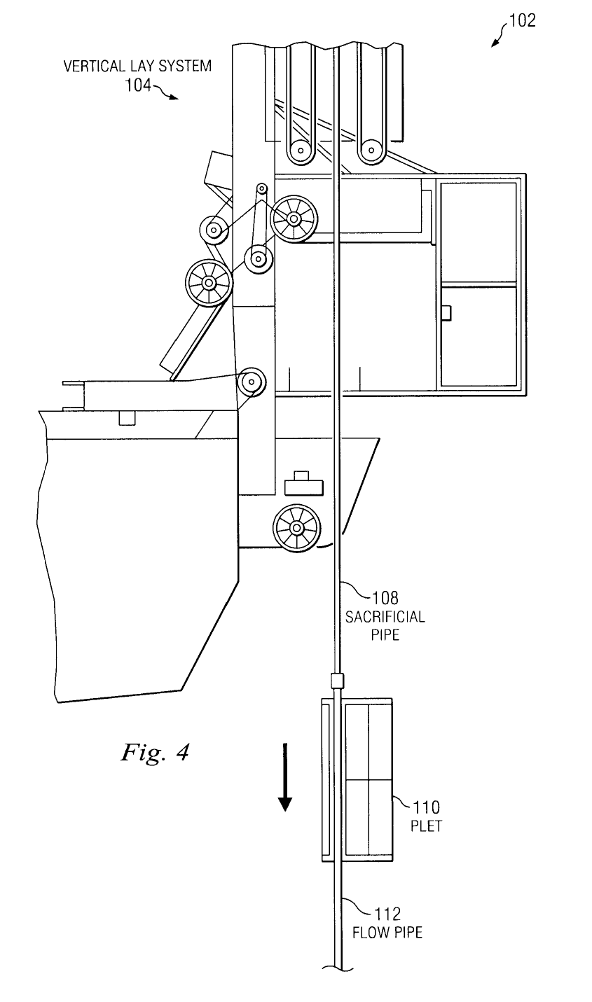

At a step 210, once the sacrificial pipe 108 has been attached to the PLET 110, the sacrificial pipe 108 is paid out over the stern of the vessel 102. This is shown in FIG. 4, where the flowpipe 112, the PLET 110, and the sacrificial pipe 108 are being lowered from the vessel 102 toward the sea floor. Moreover, it is contemplated that the flowpipe 112, the PLET 110, and the sacrificial pipe 108 can be lowered from the stern of the vessel (as shown in FIG. 4), the moon pool of the vessel, the side of the vessel, the bow of the vessel, and at any other location from the vessel.

It should be noted that the catenary shape that sacrificial pipe 108 assumes when placed into the water is taken into account in determining the necessary length of sacrificial pipe needed in order to reach the sea floor. In that regard, for example, factors such as the maximum bend radius, stress and/or strain tolerances, and the shape of sacrificial pipe 108 are considered in determining the necessary length of sacrificial pipe 108 needed in order to reach the sea floor.

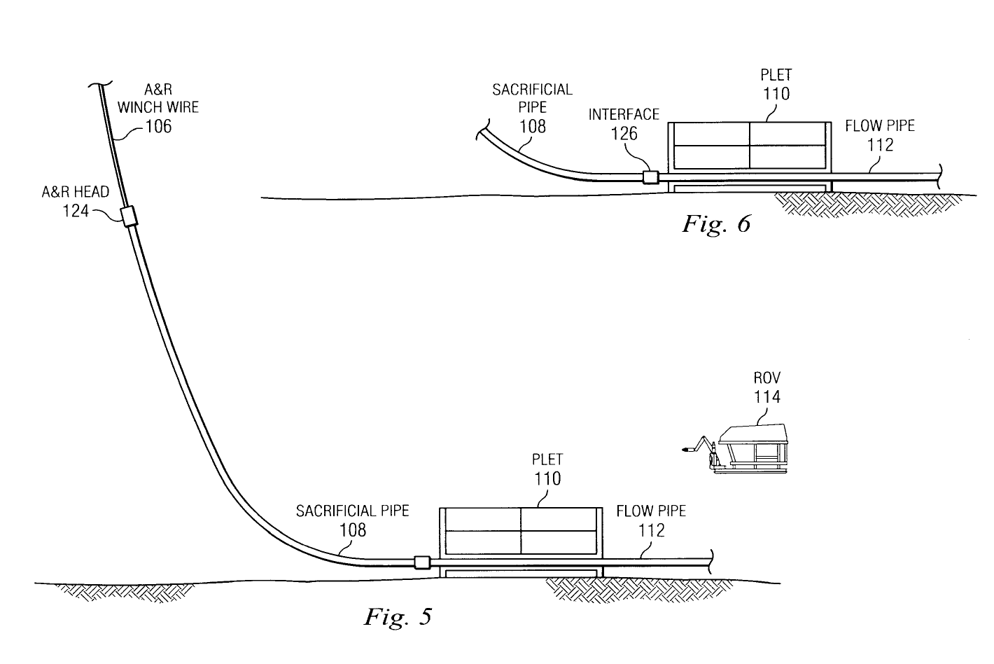

At a step 212, once the distal end 118 of the sacrificial pipe 108 reaches the workstation on the stern of the vessel 102, the sacrificial pipe is cut and an A&R head 124 (see FIG. 5) is installed onto the distal end of the sacrificial pipe, such as by welding and in turn, the A&R head 124 is connected to the A&R winch wire 106.

At a step 214, the A&R winch lowers the flowpipe 112, PLET 110, and sacrificial pipe 108 to the sea floor. This is shown in FIGS. 1 and 5, with the flowpipe 112 and PLET 110 in place on the sea floor. The sacrificial pipe 108 extends between the PLET 110 and the A&R winch wire 106 so that together, the sacrificial pipe 108 and winch wire 106 reach to the sea floor. In other words, combining the sacrificial pipe 108 with the A&R winch 106 alters the perceived length of A&R winch wire 106 so that the system can lay flowpipe 112 along the sea floor at depths exceeding the actual length of A&R winch wire 106.

Moreover, as shown in FIG. 1, vessel 102 may be moved (i.e. positioned) relative to the installed PLET 110 located on the sea floor. In other words, vessel 102 may be positioned at a layback distance L that represents an optimal position of vessel 102 relative to the point along the sea floor at which PLET 110 is installed. The layback distance L ensures that any strain and/or stress placed on sacrificial pipe 108 is minimized as the pipe assumes a catenary shape. Minimizing strains and/or stresses on sacrificial pipe 108 helps the sacrificial pipe 108 and the A&R winch wire 106 to properly position the PLET 100 and flowpipe 112 at the correct position along the sea floor.

At a step 216, once the flowpipe 112 is verified as installed in the correct position, the sacrificial pipe 108 is disconnected from the PLET 110 sub-sea by a remotely operated vehicle (ROV) 114. The ROV 114 is shown in FIG. 5 and is configured to disconnect the sacrificial pipe 108 from the PLET 110. FIG. 6 identifies an interface 126 at which the sacrificial pipe 108 is disconnected from the PLET 110.

In some examples, the sacrificial pipe 108 is removed without PLET layback. More particularly, vessel 102 may be positioned relative to PLET 110 so that the layback distance L is minimized. By removing the layback distance L, the stern of vessel 102 is aligned over PLET 110 which allows for a recovery of the sacrificial pipe 108 along a straight path. For example, the straight path may represent a path involving the shortest distance between vessel 102 and the PLET 110 along the sea floor. The use of a straight path reduces the likelihood of sacrificial pipe 108 swinging within the water depths when the ROV 114 disconnects the sacrificial pipe 108 from the PLET 110. After proper positioning of vessel 102, at a step 218, the sacrificial pipe 108 is then recovered to the surface by the A&R winch wire 106 and back onto the vessel's main reel for disposal.

The foregoing has outlined features of several embodiments. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

I claim:

1. A method of positioning a flowpipe on a sea floor from a vessel, the method comprising:
lowering a first end of a flowpipe from the vessel;
connecting a pipeline end termination to a second end of the flowpipe;
connecting a first end of a sacrificial pipe to the pipeline end termination;
connecting a winch wire to a second end of the sacrificial pipe;
lowering the sacrificial pipe with the winch wire so that the pipeline end termination rests on the sea floor; and
disconnecting the sacrificial pipe from the pipeline end termination.

2. The method of claim 1, comprising determining a sacrificial pipe length that exceeds the difference in length between a depth to the sea floor and the winch wire length.

3. The method of claim 2, comprising cutting the sacrificial pipe to the determined sacrificial pipe length.

4. The method of claim 1, wherein disconnecting the sacrificial pipe from the pipeline end termination includes operating a remote operated vehicle to disconnect the sacrificial pipe from the pipeline end termination.

5. The method of claim 1, further comprising:
determining a depth of the sea floor; and
determining that the depth of the sea floor exceeds an actual length of the winch wire.

6. The method of claim 1, further comprising:
positioning the vessel relative to pipeline end termination on the sea floor based on a property of the sacrificial pipe.

7. The method of claim 6, wherein the property of the sacrificial pipe is selected from the group consisting of maximum bend radius, stress tolerance, strain tolerance, and catenary shape of the sacrificial pipe.

8. The method of claim 1, wherein the sacrificial pipe is a rigid pipe.

9. The method of claim 8, wherein the sacrificial pipe is a straight carbon steel pipe.

10. The method of claim 1, wherein the sacrificial pipe and the flowpipe are composed of the same material.

11. The method of claim 1, further comprising:
minimizing layback by positioning the vessel substantially above the pipeline end termination; and
recovering the disconnected sacrificial pipe with the vessel substantially above the pipeline end termination.

12. A method of positioning a flowpipe on a sea floor from a floating vessel, the method comprising:
determining that a depth to the sea floor is inaccessible via a winch wire;
lowering a first end of a flowpipe from the vessel;
connecting a pipeline end termination to a second end of the flowpipe;
connecting a first end of a sacrificial pipe to the pipeline end termination;
connecting a winch wire to a second end of the sacrificial pipe;
lowering the sacrificial pipe with the winch wire until the pipeline end termination rests on the sea floor; and
disconnecting the sacrificial pipe from the pipeline end termination.

13. The method of claim 12, wherein determining that the depth to the sea floor is inaccessible via the winch wire includes comparing the length of the winch wire with the depth to the sea floor.

14. The method of claim 13, comprising determining a length of the sacrificial pipe to be connected to the pipeline end termination based on the comparison of the length of the winch wire with the depth to the sea floor.

15. A method of positioning a flowpipe on a sea floor from a floating vessel, the method comprising:
determining that the sea floor is inaccessible via a winch wire;
creating a perceived length of the winch wire different than the actual length so that the sea floor is accessible via the perceived length of the winch wire, wherein creating the perceived length of the winch wire includes connecting a sacrificial pipe to the winch wire, so that the perceived length of the winch wire is increased by the sacrificial pipe's length; and
positioning the flowpipe on the sea floor at the depth using the perceived length of the winch wire.

16. The method of claim 15, further comprising
lowering a first end of the flowpipe from the vessel;
connecting a pipeline end termination to a second end of the flowpipe;
connecting a first end of a sacrificial pipe to the pipeline end termination; and
wherein creating the perceived length of the winch wire includes connecting the winch wire to a second end of the sacrificial pipe;

17. The method of claim 16, wherein positioning the flowpipe on the sea floor at the depth using the perceived length of the winch wire includes:
lowering the sacrificial pipe with the winch wire until the pipeline end termination rests on the sea floor; and
disconnecting the sacrificial pipe from the pipeline end termination.

18. A system for laying flowpipe on a sea floor from a floating vessel, the system comprising:
a sea-going vessel comprising a winch, the winch having a winch wire having a winch wire length, the winch wire length being less than a distance from the sea-going vessel to the sea floor;
a flowpipe segment disposed on the sea floor;
a PLET disposed at an end of the flowpipe at a depth greater than the winch wire length; and
a sacrificial pipe having a pipe length, the sacrificial pipe being connected to and disposed between the PLET and the winch wire, the winch wire and the sacrificial pipe lengths together exceeding the distance from the vessel to the sea floor.

19. The system of claim 18, further comprising a remote operated vehicle to remotely disconnect the sacrificial pipe from the PLET.

20. The system of claim 18, wherein the sacrificial pipe is a rigid pipe.

21. The system of claim 18, wherein the flowpipe segments and the sacrificial pipe are composed of the same material.
